(19) United States
(12) Patent Application Publication
(10) Pub. No.: US 2006/0043115 A1
(43) Pub. Date: Mar. 2, 2006

(54) Food dispensing apparatus

(75) Inventors: Tohru Tanaka, Osaka (JP); Michinaga Kakuno, Osaka (JP)

Correspondence Address: GEORGE A. LOUD, 625 SLATERS LANE, FOURTH FLOOR, ALEXANDRIA, VA, 22314, US

(73) Assignee: TIGER CORPORATION, Osaka (JP)

(21) Appl. No.: 11/190,977

(22) Filed: Jul. 28, 2005

(30) Foreign Application Priority Data
Sep. 1, 2004 (JP) 2004-253988

(51) Int. Cl. B67D 5/06

(52) U.S. Cl. 222/181.1

(57) ABSTRACT

A food dispensing apparatus capable of dispensing various types of food, including a hopper for storing food having a food outlet, and a food discharge mechanism having a food receiving port for receiving the food from the hopper through the food outlet, a food discharging port for discharging the food, and a food passage through which the food is transferred from the food receiving port to the food discharging port. The internal capacity of the food passage is variable so that a selected amount of the food can be discharged from the food passage.

### CROSS-REFERENCE TO RELATED APPLICATION

This application claims, under 35 USC 119, priority of Japanese Patent Application No. 2004-253988, filed Sep. 1, 2004, disclosures of which, inclusive of the specification, claims and drawings, are hereby incorporated by reference herein.

### BACKGROUND OF THE INVENTION

1. Field of the Invention

This invention relates to a food dispensing apparatus which can be used to dispense various types of food and which may be suitably installed in restaurants or the like in which meals are served on a self-service basis.

2. Description of Prior Art

As a food dispensing apparatus for use in restaurants in which meals are served on a self-service basis, an apparatus for dispensing grain food such as cooked rice is known (JP-A-2004-113041). The apparatus has a food storage container with a food outlet at the bottom and a screw conveyor for transferring the food from the food outlet to a food discharging port.

In such self-serving facilities, the type of food to be dispensed is usually changed every day or every meal, so that the amount of food to be dispensed to each person should be varied depending on the type of food. In the case of the conventional apparatus using a screw conveyor, the amount of food to be dispensed can be controlled by changing the driving period of the screw conveyor. However, when the grain food dispensing apparatus is used to dispense food with a relatively large size, such as meatballs, the pieces of food are caught between the flights of the screw. Thus, various types of food dispensing apparatus should be used depending on the types of food to be dispensed.

### SUMMARY OF THE INVENTION

The present invention has been made in view of the above problem, and it is, therefore, an object of the present invention to provide a versatile food dispensing apparatus which can be used to dispense various types of food.

In accordance with a first aspect of the present invention, there is provided a food dispensing apparatus which comprises:
a food storage container for storing food, the food storage container having a food outlet; and
a food discharge mechanism having a food receiving port for receiving the food from the food storage container through the food outlet, a food discharging port for discharging the food, and a food passage through which the food is transferred from the food receiving port to the food discharging port,
wherein the internal capacity of the food passage is variable so that a selected amount of the food can be discharged from the food passage.

According to the first aspect of the present invention, the internal capacity of the food passage can be varied to vary the amount of food to be discharged from the food passage depending on the type of food. Thus, the food dispensing apparatus can be used to dispense various types of food, and there is no need to prepare various types of food dispensing apparatuses.

In accordance with a second aspect of the present invention, there is provided a food dispensing apparatus according to the first aspect, wherein the food discharge mechanism comprises a cylinder defining the food passage therein, and a plurality of screws each one of which is rotatably fitted in the food passage to transfer the food from the food receiving port to the food discharging port, the screws having different axle diameters and pitches so that the amount of the food discharged from the food discharge port can be varied by using different screws.

According to the second aspect of the present invention, the internal capacity of the food passage can be varied to vary the amount of the food to be discharged from the food passage by changing the screws. In addition, since the screws have different axle diameters and pitches, the screws can be changed depending on the size of food pieces. Thus, the food dispensing apparatus can be used to dispense various types of food, and there is no need to prepare various types of food dispensing apparatuses.

In accordance with a third aspect of the present invention, there is provided a food dispensing apparatus according to the first aspect, wherein the food discharge mechanism comprises an outer cylinder defining the food passage therein and having a cylindrical side wall provided with an opening, the outer cylinder being rotatable about its longitudinal axis between a first position where the opening is communicated with the food outlet of the food storage container to function as the food receiving port so that the food passage can receive the food from the food storage container through the food outlet and a second position where the opening faces downward to function as the food discharging port so that the food received in the food passage can be discharged by gravity, the food discharge mechanism additionally comprising an inner cylinder axially slidably fitted in the food passage such that the internal capacity of the food passage and the amount of the food discharged from the food passage can be varied by changing the axial position of the inner cylinder.

According to the third aspect of the present invention, the internal capacity of the food passage can be varied to vary the amount of the food to be discharged from the food discharge port by sliding and positioning the inner cylinder at a desired axial location in the outer cylinder. Thus, the food dispensing apparatus can be used to dispense various types of food, and there is no need to prepare various types of food dispensing apparatuses. In addition, one serving of food can be automatically measured and determined by the capacity of the food passage controlled by the inner cylinder and discharged by rotating the outer cylinder.

The food discharge mechanism described immediately above may further comprise a supporting member for rotatably supporting the outer cylinder, wherein a seal is formed between the outer cylinder and the supporting member so that the food received in the food passage is prevented from leaking out of the food passage during rotation of the outer cylinder.

In accordance with a fourth aspect of the present invention, there is provided a food dispensing apparatus according to the first aspect, wherein the food discharge mechanism comprises a cylindrical outer vessel defining the food passage therein and having a cylindrical side wall provided with an opening, the cylindrical outer vessel being rotatable about its longitudinal axis between a first position where the opening is communicated with the food outlet of the food storage container to function as the food receiving port so that the food passage can receive the food from the food storage container through the food outlet and a second position where the opening faces downward to function as the food discharging port so that the food received in the food passage can be discharged by gravity, the food discharge mechanism additionally comprising one or more inner vessels having different capacities, each one of said inner vessels being removably insertable in said cylindrical outer vessel and configured to receive the food in place of said food passage of said outer vessel when inserted in said cylindrical outer vessel assuming said first position, so that the amount of food discharged from said food passage can be varied by using the inner vessel.

According to the fourth aspect of the present invention, the internal capacity of the food passage can be varied to vary the amount of the food to be discharged from the discharging port by using the inner vessel. Thus, the food dispensing apparatus can be used to dispense various types of food, and there is no need to prepare various types of food dispensing apparatuses. In addition, one serving of food can be automatically measured and determined by the capacity of the food passage or the inner vessel and discharged by rotating the cylindrical outer vessel. Further, since the inner vessel is removable from the cylindrical outer vessel, the inner vessel can be easily cared for when the food to be dispensed is changed.

The food dispensing apparatus described immediately above may further comprise a supporting member for rotatably supporting the cylindrical outer vessel, wherein a seal is formed between the cylindrical outer vessel and the supporting member so that the food received in the food passage is prevented from leaking out of the food passage during rotation of the cylindrical outer vessel.

### BRIEF DESCRIPTION OF THE DRAWINGS

Other objects, features and advantages of the present invention will become apparent from the detailed description of the preferred embodiments of the invention which follows, when considered in the light of the accompanying drawings, in which:

FIG. 1 is an elevational cross-sectional view diagrammatically illustrating a food dispensing apparatus according to a first embodiment of the present invention;

FIG. 2 is an enlarged cross-sectional view illustrating an essential part of a food discharge mechanism of the food dispensing apparatus according to the first embodiment of the present invention;

FIG. 3 is an enlarged cross-sectional view, similar to FIG. 2, illustrating an essential part of the food discharge mechanism of the food dispensing apparatus according to the first embodiment of the present invention using another screw;

FIG. 4 is an elevational cross-sectional view diagrammatically illustrating a food dispensing apparatus according to a second embodiment of the present invention;

FIG. 5 is an elevational cross-sectional view diagrammatically illustrating a food dispensing apparatus according to a third embodiment of the present invention;

FIG. 6(a) is an enlarged cross-sectional view taken along the line VI-VI in FIG. 5, illustrating the state of a food discharge mechanism of the food dispensing apparatus at the time of receiving food;

FIG. 6(b) is an enlarged cross-sectional view, similar to FIG. 6(a), illustrating the state of a food discharge mechanism of the food dispensing apparatus at the time of discharging food;

FIG. 7(a) is an enlarged cross-sectional view of a modification of the food discharge mechanism of the food dispensing apparatus according to the fourth embodiment of the present invention, illustrating the state of the food discharge mechanism at the time of receiving food; and

FIG. 7(b) is an enlarged cross-sectional view of a modification of the food discharge mechanism of the food dispensing apparatus according to the fourth embodiment of the present invention, illustrating the state of the food discharge mechanism at the time of discharging food.

### DETAILED DESCRIPTION OF THE PREFERRED EMBODIMENTS OF THE INVENTION

Description will be hereinafter made of the preferred embodiments of the present invention with reference to the accompanying drawings.

### First Embodiment

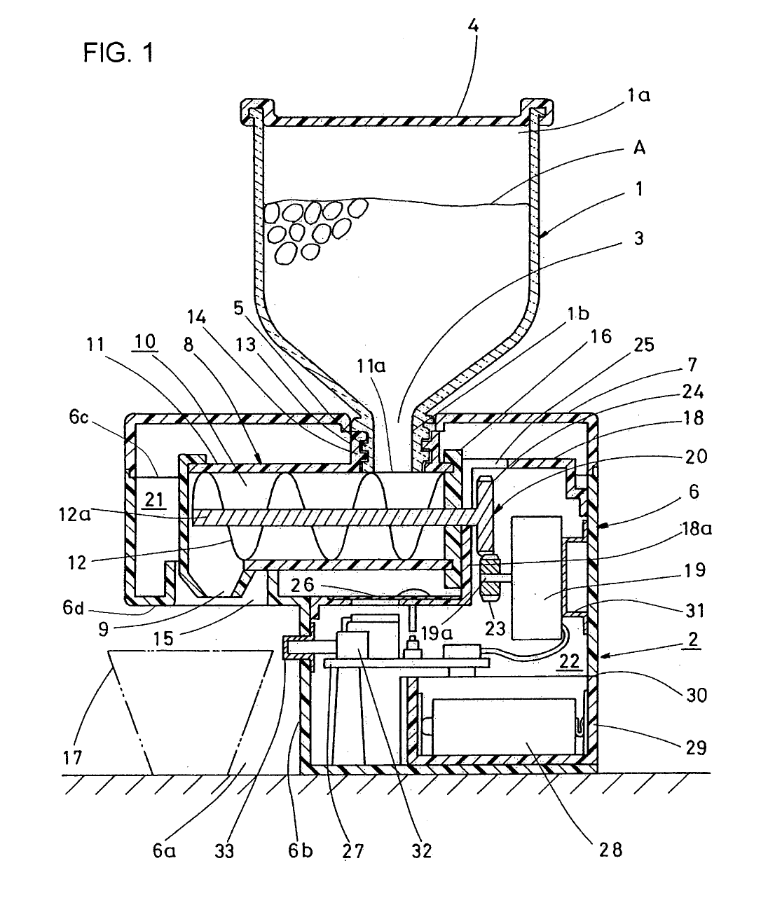

FIG. 1 through FIG. 3 show a food dispensing apparatus according to a first embodiment of the present invention.

The food dispensing apparatus has a hopper 1 as a food storage container for storing food A, and a supply unit 2 to which the hopper 1 is removably attached as shown in FIG. 1. The hopper 1 has a food outlet 3 at the bottom.

The hopper 1 is made of a transparent material (such as a transparent synthetic resin material) and has a funnel-like shape. This is convenient for the user since the food A stored in the hopper 1 is visible from outside. The hopper 1 has an upper opening 1a through which the food A is supplied and a Tupperware-type lid 4 removably attached over the upper opening 1a. The lid 4 is not necessarily transparent but preferably made of a transparent resin material so that it can be consistent with the hopper 1.

The hopper 1 has a cylindrical portion 1b formed integrally therewith at the bottom and the food outlet 3 is formed through the cylindrical portion 1b. The cylindrical portion 1b has an outer periphery with external threads 5 thereon so that the hopper 1 can be removably attached to the supply unit 2 (more specifically, to a food discharge mechanism 8).

The supply unit 2 has a body case 6 made of a synthetic resin and having an upper opening 6c, and a lid case 7 for removably closing the upper opening 6c of the body case 6. In the body case 6, a food discharge mechanism 8 is disposed.

The food discharge mechanism 8 has a circular cylindrical screw case 11 defining a horizontal food passage 10 therein and having a food receiving port 11a for receiving the food A from the hopper 1 through the food outlet 3 and a food discharging port 9 for discharging the food A, and a screw 12 which is removably received in the screw case 11 and is rotatable in the food passage 10 to transfer the food A from the food receiving port 11a to the food discharging port 9. The screw case 11 has a cylindrical portion 13 protruded from an upper part of one end thereof and having internal threads 14 adapted to engage with the external threads 5 of the cylindrical portion 1b of the hopper 1. The food receiving port 11a is defined through the cylindrical portion 13. The food discharging port 9 opens downward at a lower part of the other end of the screw case 11. The body case 6 has a recess 6a in one side to form a space to place a food receiving vessel 17 as shown in FIG. 1. The food discharging port 9 is located above a food feeding opening 15 formed through a wall 6d defining the upper side of the recess 6a of the body case 6. Designated as 16 is a lid of the screw case 11, which is removable from the screw case 11.

The screw 12 has an axle 12a having an end projected through the lid 16 of the screw case 11 and a vertical portion 18a of a partition 18 with an inverted L-shaped cross-section located in the body case 6 and supporting the end of the axle 12a. The end of the axle 12 is connected to an axle 19a of a motor 19 as a driving source via a speed reduction mechanism 20. The partition 18 divides the inside of the body case 6 into a discharge mechanism chamber 21 on the upper side and a machine chamber 22 on the lower side. The speed reduction mechanism 20 has a small-diameter gear 23 mounted on the end of the axle 19a of the motor 19 and a large-diameter gear 24 mounted on the end of the axle 12a of the screw 12. The large-diameter gear 24 in meshing engagement with an upper part of the small-diameter gear 23, so that the large-diameter gear 24 can be easily separated from the small-diameter gear 23 when it is moved upward. The food discharge mechanism 8 is provided with a plurality of screws, including the screw 12, which are generally the same in construction except for having different axle diameters and pitches.

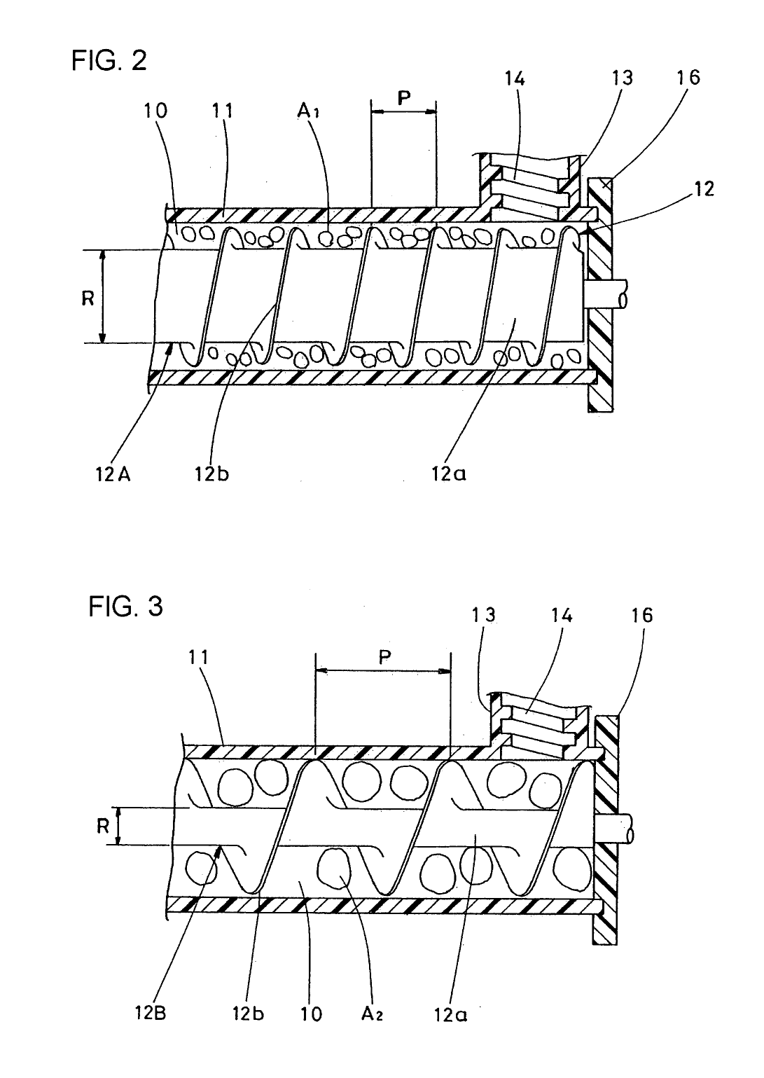

The food discharge mechanism 8 including the screw case 11, the screw 12 and the large-diameter gear 24 can be removed upward from the body case 6 when the hopper 1 and the lid case 7 have been removed. When the food discharge mechanism 8 has been removed from the body case 6, the screw 12 can be removed together with the lid 16 from the screw case 11 and changed for another screw. For example, a screw 12A having an axle 12a with a large diameter R and flights 12b with a small pitch P as shown in FIG. 2 is suitable to transfer food A₁ with pieces having a relatively small size such as fried rice, and a screw 12B having an axle 12a with a small diameter R and a flight 12b with a large pitch P as shown in FIG. 3 is suitable to transfer food A₂ with pieces having a relatively large size such as meatballs. That is, the internal capacity of the food passage 10 can be varied depending on the types of food by changing the screws. Thus, the food dispensing apparatus can be used to dispense various types of food, and there is no need to prepare various types of food dispensing apparatuses. Designated as 25 is an opening formed through the partition 18 and having a size which allows passage of the large-diameter gear 24 when the food discharge mechanism 8 is removed.

An operation panel 26 with which the settings of the food dispensing apparatus can be made is provided on the upper side of that part of the partition 18 located below the screw case 11.

The motor 19, a control board 27 for controlling the motor 19 and so on, and a battery box 29 in which a battery 28 as a power source of the motor 19 is housed are arranged in the machine chamber 22. The battery box 29 can be put in and out of the machine chamber 22 through an opening 30 formed through a lower part of one side of the body case 6. Designated as 31 is a motor supporting member for supporting the motor 19 on an inner wall of the body case 6.

The recess 6a of the body case 6 has a bottom wall 6b (which also serves as a side wall of the machine chamber 22), on which an operation knob 33 of a driving start switch 32 for starting the motor 19 is provided. The driving start switch 32 is provided on the control board 27.

The above food dispensing apparatus operates as follows.

When the food A is charged in the hopper 1 with the lid 4 of the hopper removed and the operation knob 33 of the driving start switch 32 is turned on, the motor 19 starts to be driven. The driving force of the motor 19 is transmitted to the axle 12a of the screw 12 via the speed reduction mechanism 20 to rotate the screw 12. That is, the food discharge mechanism 8 starts to be driven. When the screw 12 is rotated, the food A in the hopper 1 is transferred through the food passage 10 and discharged from the food discharging port 9 into the food receiving vessel 17. The amount of food to be discharged at this time is determined by the period of time for which the screw 12 is rotated (in other words, the driving period of the motor 19). The driving period of the motor 19 is set in advance by a microcomputer chip (not shown) on the control board 27. The motor 19 is preferably rotated in reverse for a predetermined period of time when the driving period of the motor 19 reaches the preset time period so that the food A is not unnecessarily discharged from the food passage 10.

In hotels or restaurants in which meals are served on a self-service basis, various types of food with pieces having different shapes and sizes are served. In this embodiment, therefore, a plurality of screws are provided such that the screws can be changed depending on the type of food.

That is, the internal capacity of the food passage 10 can be varied by changing the screws, for example, by changing the screw 12A shown in FIG. 2 to the screw 12B shown in FIG. 3 or vise versa. Thus, the food dispensing apparatus can be used to dispense various types of food, and there is no need to prepare various types of food dispensing apparatuses.

### Second Embodiment

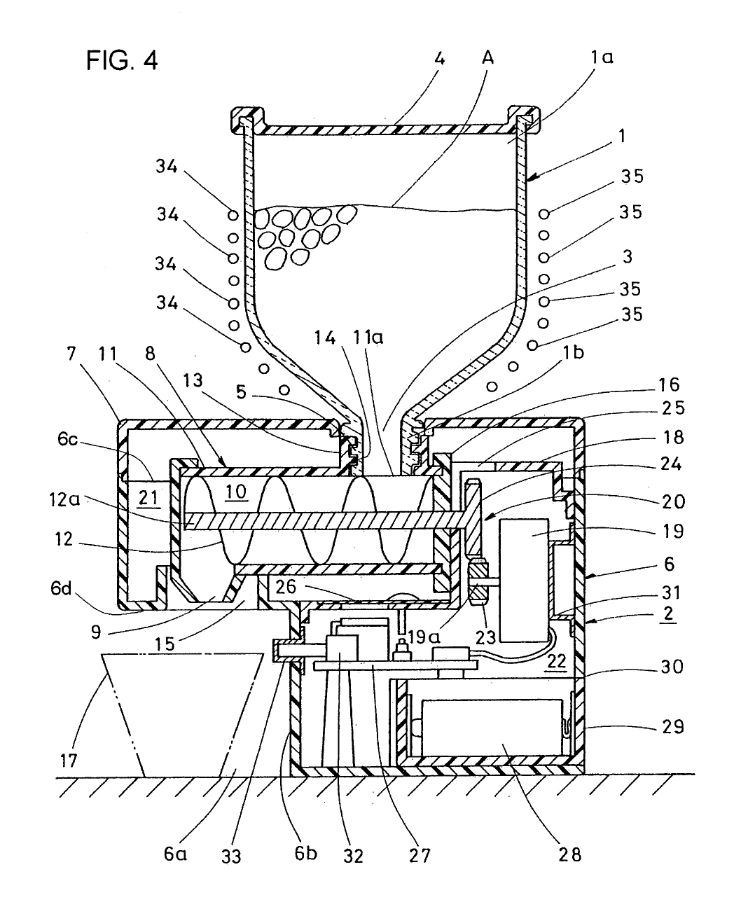

FIG. 4 shows a food dispensing apparatus according to a second embodiment of the present invention. Those parts corresponding to the component parts of FIG. 1 are identified with the same reference numerals.

In this embodiment, light emitting elements 34, 34, . . . arranged at specific intervals along one side of the transparent hopper 1 are opposed to corresponding light receiving elements 35, 35, . . . arranged at specific intervals along the other side of the hopper 1. The emission of light from the light emitting elements 34, 34, . . . , the reception of signals from the light receiving elements 35, 35, . . . , and the output of a control signal to the motor 19 are controlled by a microcomputer chip (not shown) on the control board 27. When the food discharge mechanism 8 discharges the food A and the amount of the food A in the hopper 1 decreases, the decrease of the food A can be acquired by determining which light receiving elements 35, 35, . . . receive light beams from the light emitting elements 34, 34, . . . . Thus, when the motor 19 is configured to stop based on light reception signals from the light receiving elements 35, 35, . . . , a selected amount of food can be discharged. The amount of food to be discharged can be controlled by adjusting the intervals between the light emitting elements 34, 34, . . . and the light receiving elements 35, 35, . . . or changing the inside diameter of the hopper 1. The second embodiment is suitable for food like cereals and liquid or powder type food. The other configuration and the effects are the same as those of the first embodiment and hence their description is omitted.

### Third Embodiment

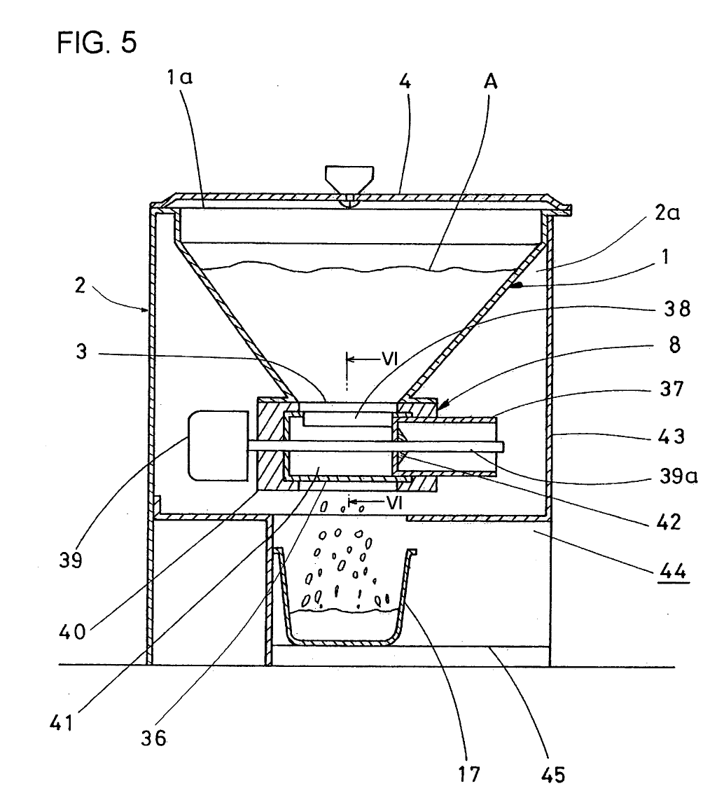

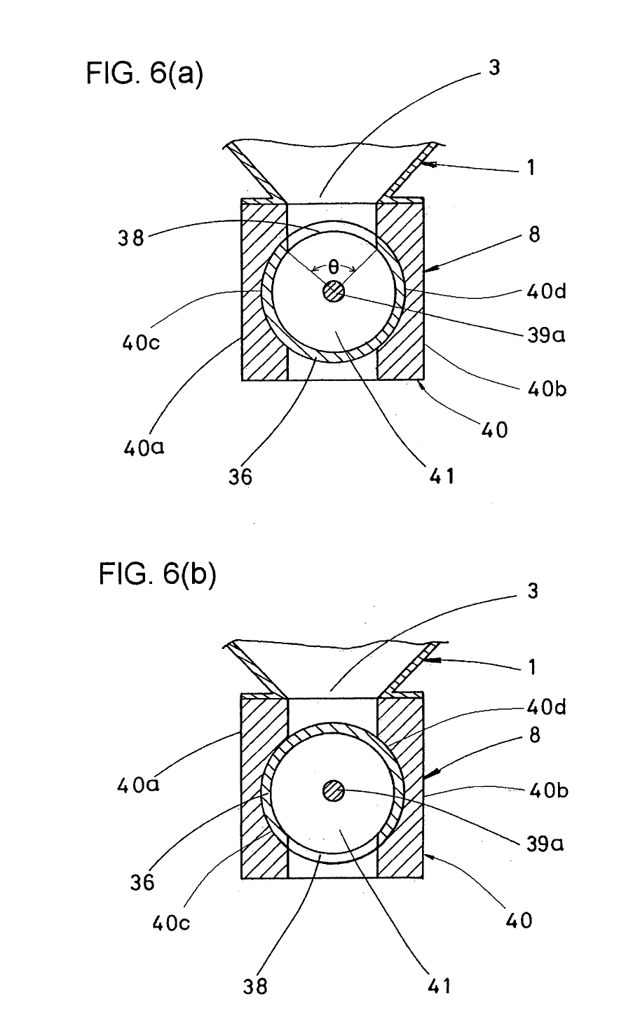

FIGS. 5, 6(a) and 6(b) show a food dispensing apparatus according to a third embodiment of the present invention.

The food dispensing apparatus has a hopper 1 as a food storage container for storing food A, and a supply unit 2 housing the hopper 1 as shown in FIG. 5. The hopper 1 has a food outlet 3 at the bottom The hopper 1 has an upper opening 1a, and a lid 4 removably attached over the upper opening 1a.

A food discharge mechanism 8 is removably attached to a lower part of the hopper 1.

The food discharge mechanism 8 includes an outer cylinder 36 defining a food passage 41 therein and having a cylindrical side wall provided with an opening 38, a supporting member 40 for rotatably supporting the outer cylinder 36, and an inner cylinder 37 axially slidably fitted in the outer cylinder 36. The opening 38 of the outer cylinder 36 extends along almost the entire length of the outer cylinder 36 and has a width corresponding to an angle θ, as shown in FIG. 6(a), about the longitudinal axis of the outer cylinder 36. The angle θ is generally in the range of about 60 to 120°, preferably about 90°. The outer cylinder 36 is rotatable between a first position, shown in FIG. 6(a), where the opening 38 is communicated with the food outlet 3 of the hopper 1 to function as a food receiving port and a second position, shown in FIG. 6(b), where the opening 38 faces downward to function as a food discharging port. The outer cylinder 36 is driven by a motor 39, which has an axle 39a. The axis of the axle 39a of the motor 39 coincides with the longitudinal axis of the outer cylinder 36 so that the outer cylinder 36 is rotatable about its longitudinal axis. The inner cylinder 37 is supported by the axle 39a of the motor 39 and is manually slidable in the outer cylinder 36 so that the internal capacity of the food passage 41 can be varied. Designated as 42 is a stopper for positioning the inner cylinder 37. The supporting member 40 includes a pair of supporting walls 40a and 40b opposed to each other and having arcuate recesses 40c and 40d, respectively, that receive the outer cylinder 36. A seal is formed between the outer cylinder 36 and the supporting walls 40a and 40b of the supporting member 40A so that the food A received in the outer cylinder 36 (food passage 41) can be prevented from leaking out of the outer cylinder 36 (food passage 41) during rotation of the outer cylinder 36. The outer cylinder 36 may be manually driven in place of the motor power, if desired. The inner cylinder 37 may be axially driven by a motor, if desired.

The supply unit 2 has an opening 2a on one side and a cover 43 is removably attached over the opening 2a so that the inner cylinder 37 of the food discharge mechanism 8 can be slid forward or backward when the cover 43 is removed. The supply unit 2 has a recess 44 in one side to form a space to place a food receiving vessel 17 as shown in FIG. 5. A table 45 to carry a food receiving vessel 17 is slidably provided in the recess 44.

The above food dispensing apparatus operates as follows.

When the food A is charged in the hopper 1 with the lid 4 of the hopper 1 removed, the food A is filled by gravity in the food passage 41 of the outer cylinder 36 through the opening 38 (see FIG. 6(a)). When the motor 39 is driven in this state to turn the outer cylinder 36 upside down, the opening 38 of the outer cylinder 36 faces downward (see FIG. 6(b)). Then, the food A in the food passage 41 is discharged by gravity through the opening 38 and received into the food receiving vessel 17. The amount of the food A to be discharged at a time can be adjusted by sliding the inner cylinder 37 forward or backward to vary the internal capacity of the food passage 41.

In hotels or restaurants in which meals are served on a self-service basis, various types of food with pieces having different shapes and sizes are served, so that the amount of food to be dispensed to each person should be varied depending on the type of food. According to the third embodiment of the present invention, the internal capacity of the food passage 41 can be varied to change the amount of food to be discharged by sliding the inner cylinder 37. Thus, the food dispensing apparatus can be used to dispense various types of food.

### Fourth Embodiment

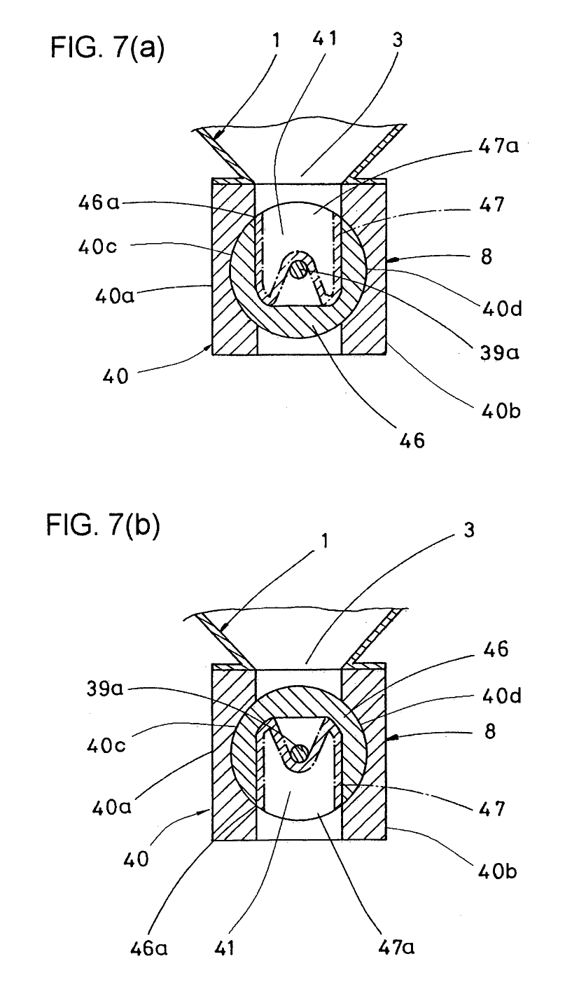

FIGS. 7(a) and 7(b) show a fourth embodiment of the present invention which is a modification of the food dispensing apparatus according to the third embodiment and which differs from the third embodiment in structure of the food discharge mechanism. In FIGS. 7(a) and 7(b), the same reference numerals as those in FIGS. 6(a) and 6(b) designate similar features.

The food discharge mechanism 8 of the fourth embodiment includes a cylindrical outer vessel 46 defining a food passage 41 therein and having a cylindrical side wall provided with an opening 46a, and a supporting member 40 for rotatably supporting the cylindrical outer vessel 46. The opening 46a of the cylindrical outer vessel 46 extends along almost the entire length of thereof. The cylindrical outer vessel 46 is rotatable between a first position, shown in FIG. 7(a), where the opening 46a is communicated with a food outlet 3 of a hopper 1 to function as a food receiving port and a second position, shown in FIG. 7(b), where the opening 46a faces downward to function as a food discharging port. The cylindrical outer vessel 46 is driven by a motor (not shown) having an axle 39a. The axis of the axle 39a of the motor coincides with the longitudinal axis of the cylindrical outer vessel 46 so that the cylindrical outer vessel 46 is rotatable about its longitudinal axis. When the food in the hopper 1 is filled by gravity in the food passage 41 of the cylindrical outer vessel 46 through the outlet 3 and opening 46a (FIG. 7(a)) and when the motor is driven in this state to turn the cylindrical outer vessel 46 upside down, the opening 46a of the cylindrical outer vessel 46 faces downward (FIG. 7(b)). Thus, the food in the food passage 41 is discharged by gravity through the opening 46a in the same manner as that in the third embodiment.

When the amount of food to be dispensed is desired to be reduced as a result of the change in food, an inside vessel 47 shown by the phantom line in FIGS. 7(a) and 7(b) is inserted in the cylindrical outer vessel 46. The inside vessel 47 has an aperture 47a and is removably insertable in the cylindrical outer vessel 46. The inner vessel 47 is configured to receive the food in place of the food passage 41 of the cylindrical outer vessel 46 when inserted in the cylindrical outer vessel 46, so that the amount of food discharged from said food passage can be varied by using the inner vessel. Thus, when the inner vessel 47 is inserted in the cylindrical outer vessel 46 in position, the opening 46a of the cylindrical outer vessel 46 is substituted by the aperture 47a of the inner vessel 47 and the food passage 41 of the cylindrical outer vessel 46 is substituted by the space of the inner vessel 47.

As a result of the above construction, when the cylindrical outer vessel 46 in which the inner vessel 47 is mounted in position is in the first position, the inner vessel 47 receives the food from the hopper 1 through the outlet 3 and the aperture 47a. When the cylindrical outer vessel 46 is turned upside down to assume the second position, the food in the inner vessel 47 is discharged through the aperture 47a by gravity. The food discharge mechanism 8 is provided with one or more inner vessels having different capacities and each insertable in the cylindrical outer vessel 46. Thus, the internal capacity of the food passage 41 can be varied by changing the inner vessels. The food dispensing apparatus therefore can dispense the food in various amounts and can be used to dispense various types of food. Further, since the inner vessels are removably receivable in the outer vessel, the inner vessels can be easily cared for after use.

The other construction and effects of the fourth embodiment are the same as those of the third embodiment described above and hence their description is omitted.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description, and all the changes which come within the meaning and range of equivalency of the claims are therefore intended to be embraced therein.

What is claimed is:

1. A food dispensing apparatus comprising:
a food storage container for storing food, said food storage container having a food outlet; and
a food discharge mechanism having a food receiving port for receiving the food from said food storage container through said food outlet, a food discharging port for discharging the food, and a food passage through which the food is transferred from said food receiving port to said food discharging port,
wherein the internal capacity of said food passage is variable so that a selected amount of the food can be discharged from said food passage.

2. A food dispensing apparatus as recited in claim 1, wherein said food discharge mechanism comprises a cylinder defining said food passage therein, and a plurality of screws each one of which is rotatably fitted in said food passage to transfer the food from said food receiving port to said food discharging port, said plurality of screws having different axle diameters and pitches so that the amount of the food discharged from said food discharge port can be varied by using different screws.

3. A food dispensing apparatus as recited in claim 1, wherein said food discharge mechanism comprises an outer cylinder defining said food passage therein and having a cylindrical side wall provided with an opening, said outer cylinder being rotatable about its longitudinal axis between a first position where said opening is communicated with said food outlet of said food storage container to function as said food receiving port so that said food passage can receive the food from said food storage container through said food outlet and a second position where said opening faces downward to function as said food discharging port so that the food received in said food passage can be discharged by gravity, said food discharge mechanism additionally comprising an inner cylinder axially slidably fitted in said food passage such that the internal capacity of said food passage and the amount of the food discharged from said food passage can be varied by changing the axial position of said inner cylinder.

4. A food dispensing apparatus as recited in claim 3, wherein said food discharge mechanism further comprising a supporting member for rotatably supporting said outer cylinder, wherein a seal is formed between said outer cylinder and said supporting member so that the food received in said food passage is prevented from leaking out of said food passage during rotation of said outer cylinder.

5. A food dispensing apparatus as recited in claim 1, wherein said food discharge mechanism comprises a cylindrical outer vessel defining said food passage therein and having a cylindrical side wall provided with an opening, said cylindrical outer vessel being rotatable about its longitudinal axis between a first position where said opening is communicated with said food outlet of said food storage container to function as said food receiving port so that said food passage can receive the food from said food storage container through said food outlet and a second position where said opening faces downward to function as said food discharging port so that the food received in said food passage can be discharged by gravity, said food discharge mechanism additionally comprising one or more inner vessels having different capacities, each one of said inner vessels being removably insertable in said cylindrical outer vessel and configured to receive the food in place of said food passage of said cylindrical outer vessel when inserted in said cylindrical outer vessel assuming said first position, so that the amount of food discharged from said food passage can be varied by using the inner vessel.

6. A food dispensing apparatus as recited in claim 5, wherein said food discharge mechanism further comprises a supporting member for rotatably supporting said cylindrical outer vessel, wherein a seal is formed between said cylindrical outer vessel and said supporting member so that the food received in said food passage is prevented from leaking out of said food passage during rotation of said cylindrical outer vessel.
